(19) United States
(12) Patent Application Publication
(10) Pub. No.: US 2011/0289328 A1
(43) Pub. Date: Nov. 24, 2011

(54) UNIVERSAL SERIAL BUS ASSEMBLY STRUCTURE

(76) Inventor: JEN-JEN CHENG, New Taipei City (TW)

(21) Appl. No.: 13/195,019

(22) Filed: Aug. 1, 2011

Related U.S. Application Data
(63) Continuation-in-part of application No. 11/797,639, filed on May 4, 2007.

(51) Int. Cl. G06F 1/26

(52) U.S. Cl. 713/300

(57) ABSTRACT

A USB (Universal Serial Bus) assembly structure is composed of a power supply device, a lead wire, an electromagnetic wave elimination device, a power adapter, and a plug, wherein a side of the lead wire is provided with a USB power supply device, such that when a computer is not turned on or is hibernated, power can be still supplied by the USB power supply device. In addition, when a computer is not provided with enough USB slots, it is still convenient to supply the USB power.

### CROSS-REFERENCE TO RELATED APPLICATION

This is a continuation-in-part of the co-pending patent application Ser. No. 11/797,639, filed May 4, 2007.

### BACKGROUND OF THE INVENTION

1. Field of the Invention

This invention relates to a USB (Universal Serial Bus) assembly structure, and more particularly to a USB assembly structure which is provided with a USB power supply device being installed at a power supply of a computer, such that when the computer is not turned on, is hibernated, or is not provided with enough USB slots, the USB power supply function is still available.

2. Description of the Prior Art

Referring to FIG. 1, a conventional power supply device A is constituted by a plug A1, a power adapter A2, an electromagnetic wave elimination device A3, and a lead wire A4. As the power supply device A is not provided with a USB (Universal Serial Bus) power supply function, therefore, if it is required to supply power through the USB, a USB slot of a computer is still needed. Moreover, when the computer is turned off, in a hibernation state, or not provided with enough USB slots, the USB power supply function is not available.

Accordingly, how to eliminate the aforementioned problems is a technical issue to be solved by the present inventor.

### SUMMARY OF THE INVENTION

The primary object of present invention is to provide a USB (Universal Serial Bus) assembly structure which is provided with a USB power supply device being installed at a side of lead wire of a computer power supply device, such that when the computer is not turned on, is hibernated, or is not provided with enough USB slots, the USB power supply function is still available.

To enable a further understanding of the said objectives and the technological methods of the invention herein, the brief description of the drawings below is followed by the detailed description of the preferred embodiments.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows a perspective view of a conventional power supply device.

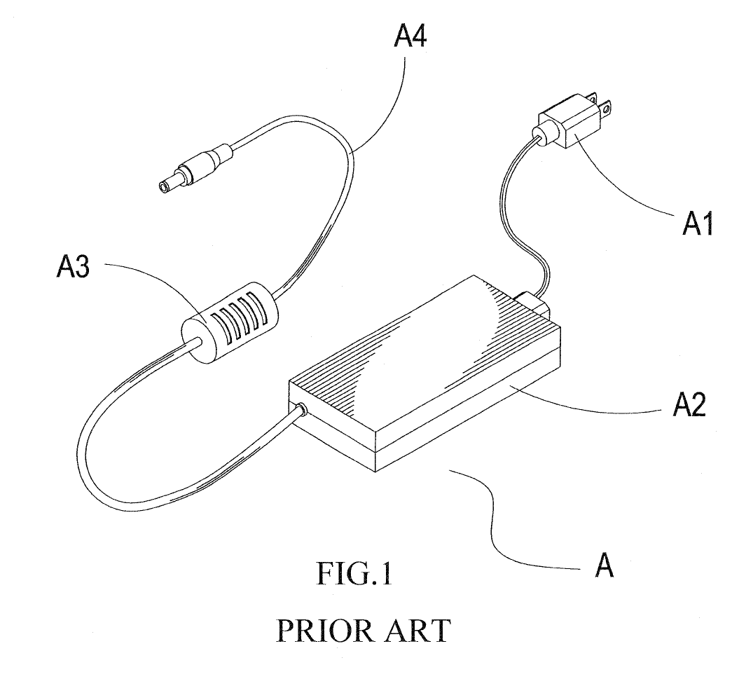

FIG. 2 shows a perspective view of the present invention.

FIG. 3 shows a first schematic view of an embodiment of the present invention.

FIG. 4 shows a second schematic view of an embodiment of the present invention.

FIG. 5 shows a third schematic view of an embodiment of the present invention.

FIG. 6 shows a fourth schematic view of an embodiment of the present invention.

FIG. 7 shows a fifth schematic view of an embodiment of the present invention.

FIG. 8 shows a first schematic view of a further embodiment of the present invention.

FIG. 9 shows a second schematic view of a further embodiment of the present invention.

FIG. 10 shows a third schematic view of a further embodiment of the present invention.

FIG. 11 illustrates a further embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

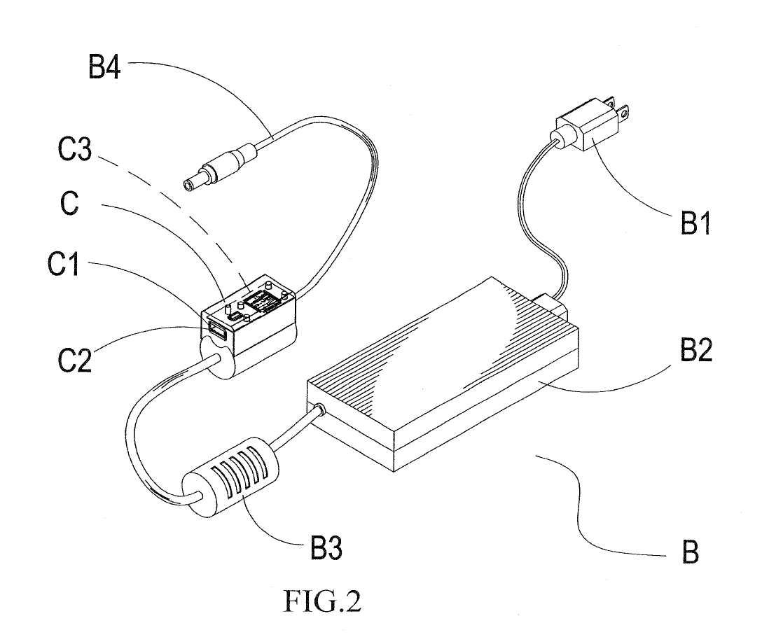

Referring to FIG. 2, the present invention is to provide a USB (Universal Serial Bus) assembly structure which includes a power supply device B, a plug B1, a power adapter B2, an electromagnetic wave elimination device B3, and a lead wire B4, wherein a side of the lead wire B4 is disposed with a USB power supply device C which is installed with a USB socket C1 for receiving a USB plug. The USB power supply device C is provided with an electronic voltage conversion device C3. The USB socket C1 is provided with a plurality of conduction terminals C2 for assembling with a 3C electronic product and for supplying power. Through the USB power supply device C at the lead wire B4, a user can use a USB connector to supply power to an electronic product at the same time when the power supply device B is conducted.

Referring to FIGS. 2 to 7, the USB power supply device C is located at one side of the lead wire B4. After the plug B1 is inserted into a power socket (shown but not numbered), electrical power can pass through the power adapter B2 via the lead wires B4 and B5, and electromagnetic waves generated when electric current passes through the lead wires B4 and B5 can be eliminated by the electromagnetic wave elimination device B3. When the electric current passes through the USB power supply device C at the lead wire B4, as the USB socket C1 of the USB power supply device C is provided with the conduction terminals C2, a 3C electronic product can be assembled and conducted, thereby achieving a function of supplying power.

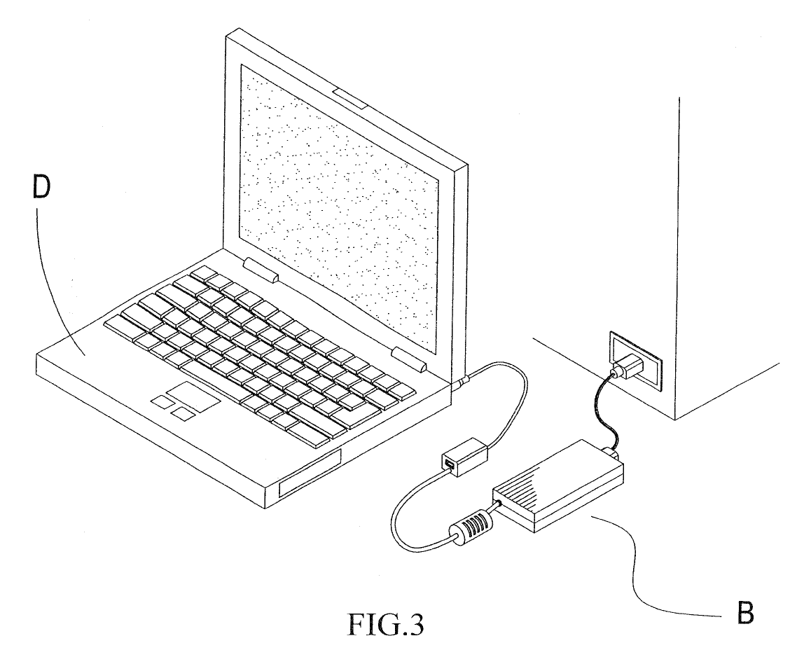

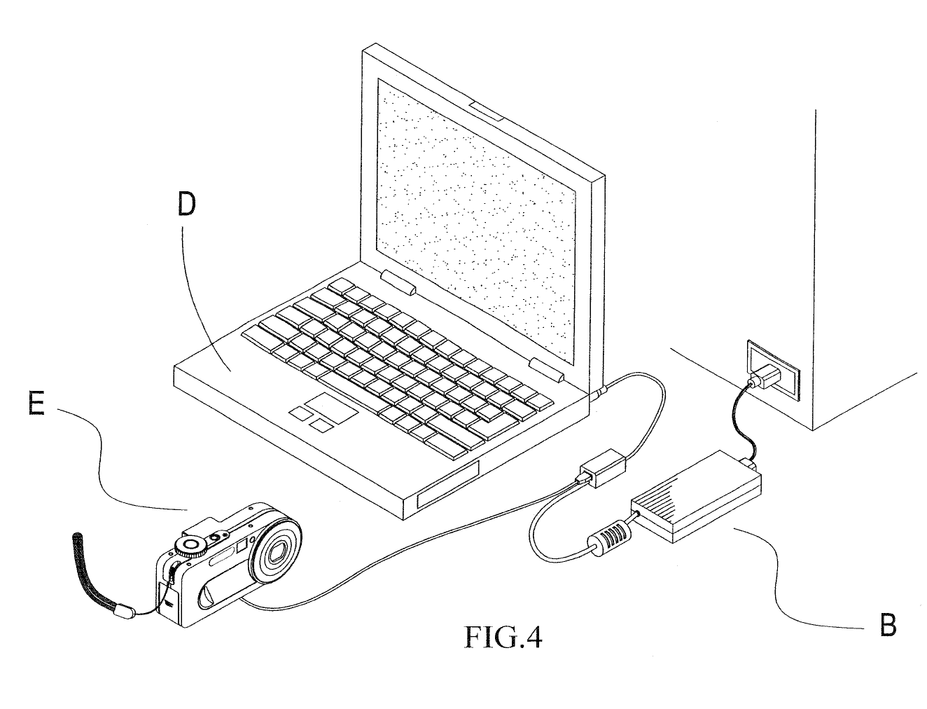

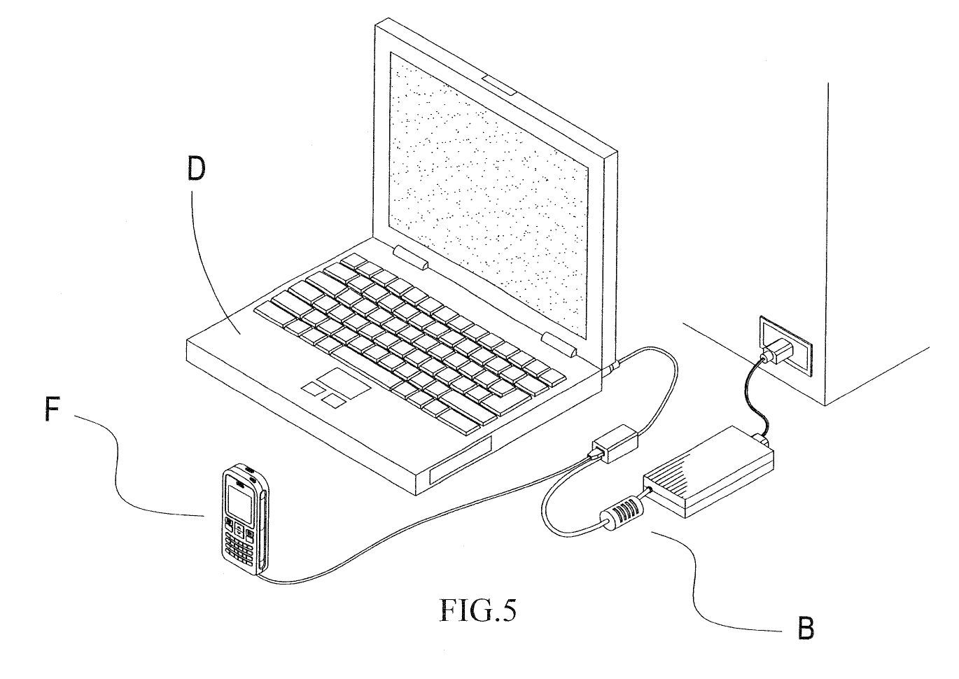

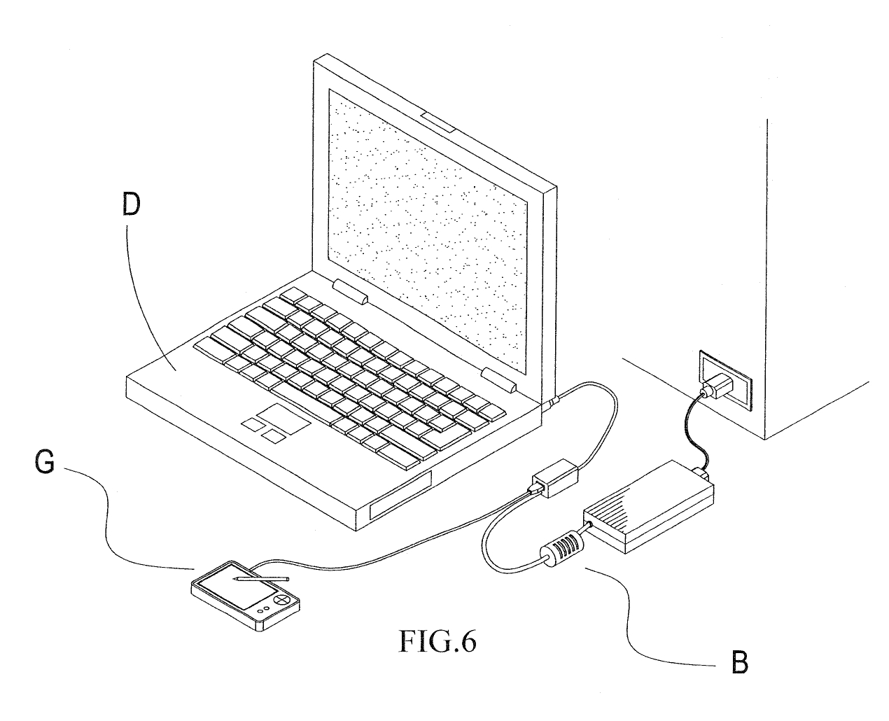

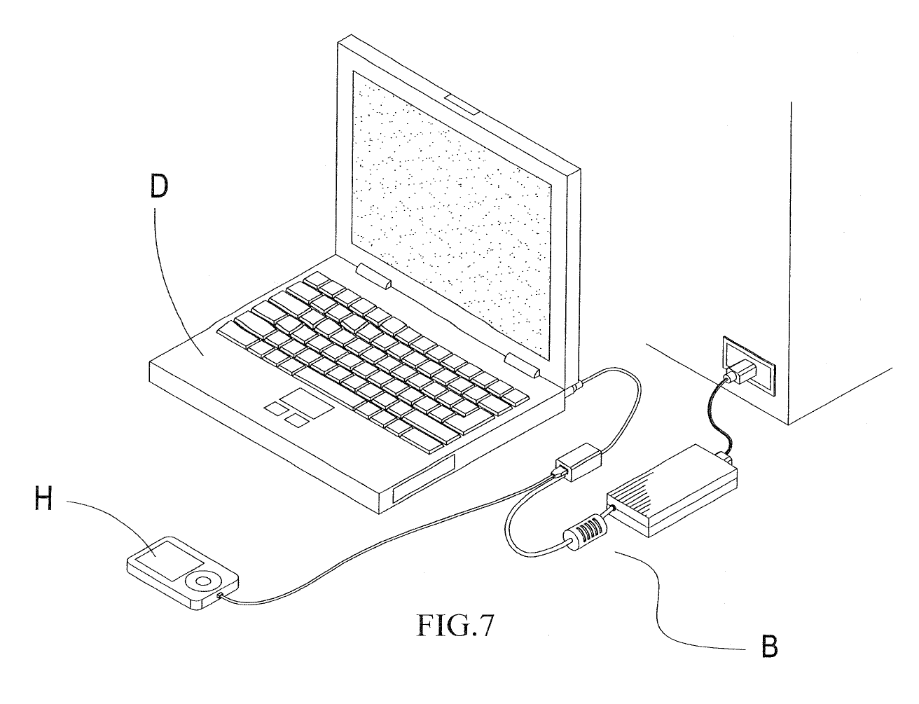

Furthermore, after the plug B1 of power supply device B is inserted into the power socket, power can be provided to a computer D (see FIG. 3). In addition, the USB power supply device C at the lead wire B4 can also provide electrical power to a camera E via a USB connector connected between the USB socket C1 and the camera E (see FIG. 4), a cellular phone F via a USB connector connected between the USB socket C1 and the cellular phone (see FIG. 5), a PDA (Personal Digital Assistant) G via a USB connector connected between the USB socket Cl and the PDA (see FIG. 6), or an iPod H via a USB connector connected between the USB socket C1 and the iPod H (see FIG. 7).

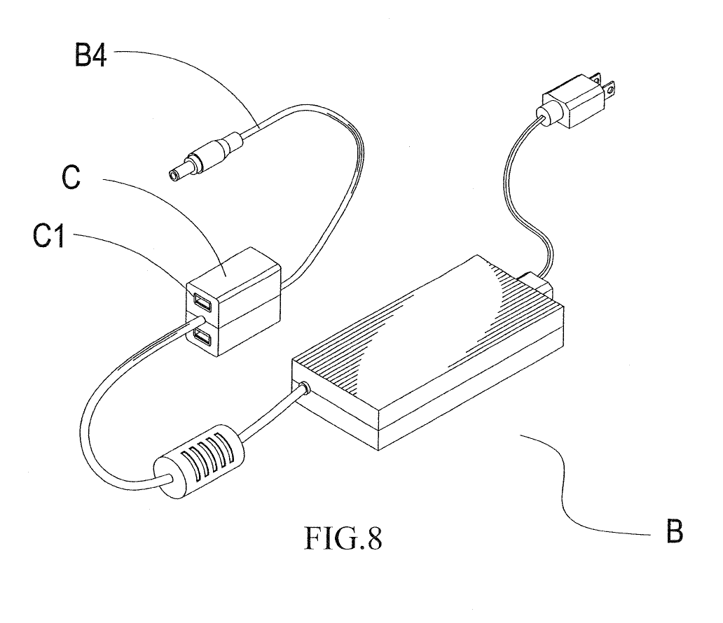

Referring to FIG. 8, the power supply device B can be further provided with a plurality of USB power supply devices C stacked up at the lead wire B4, with a plurality of USB sockets C1 for supplying power.

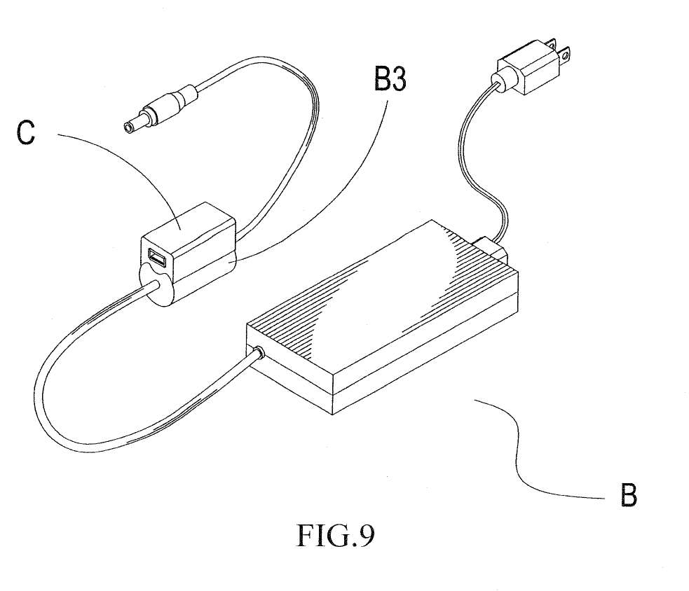

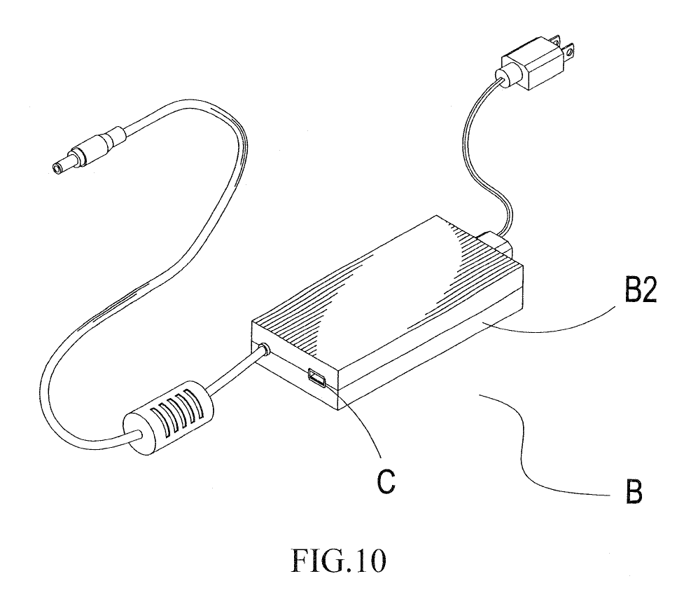

Referring to FIG. 9 and FIG. 10, the USB power supply device C of the power supply device B can be further configured at the electromagnetic wave elimination device B3, and can be also further configured at the power adapter B2 to proceed with supplying the USB power.

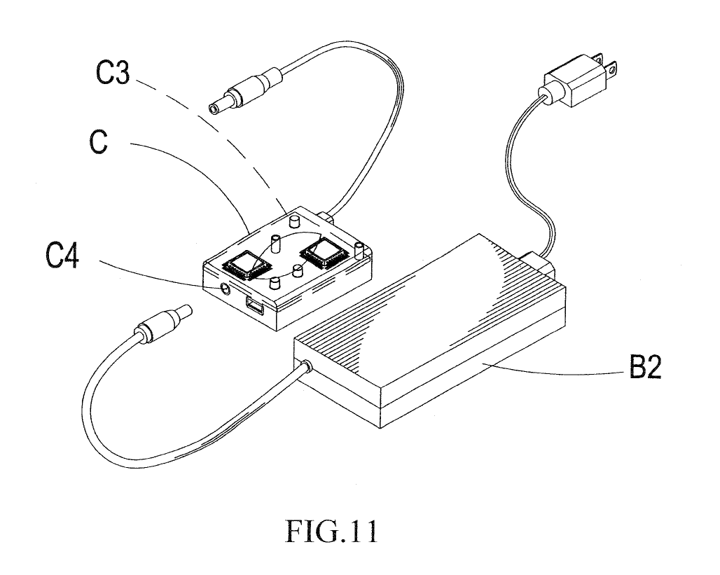

Referring to FIG. 11, the USB power supply device C may be a separate device which is provided with a power socket C4 thereby making it possible to connect with different power adapters B2.

Furthermore, the USB power supply device is further configured as a connector, including a USB interface slot, an SATA (Serial Advanced Technology Attachment) interface slot, or an HDMI (High-Definition Multimedia Interface) slot.

In order to further manifest advancement and practicability of the present invention, it is compared with a conventional device as below.

Shortcomings of a Conventional Device:

1. The USB power should be supplied from a computer which can provide the USB power and cannot be directly provided by a power device.

2. When the computer is turned off, hibernated, or not provided with enough USB slots, the USB power supply function is not available.

3. According to item 2, it is in lack of convenience. Advantages of the present invention:

1. Power can be supplied directly from the USB power supply device which is installed by a power device.

2. Supplying the USB power can be carried out without turning on a computer.

3. According to item 1, it is provided with convenience.

4. According to item 2, it is provided with practicability.

5. It can save space to be used.

6. It is provided with advancement and practicability

7. It can improve industrial competitiveness.

8. When it is used with larger input voltage ranges, the voltage will be automatically adjusted by the voltage conversion device C3 into stable voltage suitable for use with USB, thereby making it unnecessary to have any changes to the components of the USB power supply device C for use with different adapters B2.

9. The USB power supply device C may be a separate device which is provided with a socket C4 thereby making it possible to connect with different power adapters B2.

It is of course to be understood that the embodiments described herein is merely illustrative of the principles of the invention and that a wide variety of modifications thereto may be effected by persons skilled in the art without departing from the spirit and scope of the invention as set forth in the following claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A USB (universal serial bus) assembly structure comprising:
a power adapter;
a plug electrically connected with an input end of said power adapter;
an electromagnetic wave elimination device having an input end electrically connected with an output end of said power adapter;
a USB power supply device having an input end electrically connected with an output end of said electromagnetic wave elimination device, said USB power supply device having at least a USB socket for inserting a USB plug, said USB power supply device being provided with an electronic voltage conversion device; and
a lead wire electrically connected with an output end of said USB power supply device.

2. The USB (universal serial bus) assembly structure as claimed in claim 1, wherein said USB power supply device is further configured as a connector, including a USB interface slot, an SATA (Serial Advanced Technology Attachment) interface slot, or an HDMI (High-Definition Multimedia Interface) slot.

3. A USB (universal serial bus) assembly structure comprising:
a power adapter;
a plug electrically connected with an input end of said power adapter;
a USB power supply device being provided with an electronic voltage conversion device and an electromagnetic wave elimination device, said USB power supply device having at least a USB socket for inserting a USB plug and a power socket connectable with said power adapter; and
a lead wire electrically connected with an output end of said USB power supply device.

4. The USB (universal serial bus) assembly structure as claimed in claim 3, wherein said USB power supply device is further configured as a connector, including a USB interface slot, an SATA (Serial Advanced Technology Attachment) interface slot, or an HDMI (High-Definition Multimedia Interface) slot.
